(19) United States
(12) Patent Application Publication
(10) Pub. No.: US 2026/0295707 A1
(43) Pub. Date: Oct. 1, 2026

(54) Omni-Directional Melt Pool Viewer

(71) Applicants: Michael David McAninch, Goode, VA (US); Robert Bruce Madigan, Anaconda, MT (US); Jeffrey J. Root, Bryan, OH (US); Darren Lee Wright, Zanesville, OH (US); Tate Patterson, Jerome, ID (US); Dale J. Brush, Manhattan, MT (US)

(72) Inventors: Michael David McAninch, Goode, VA (US); Robert Bruce Madigan, Anaconda, MT (US); Jeffrey J. Root, Bryan, OH (US); Darren Lee Wright, Zanesville, OH (US); Tate Patterson, Jerome, ID (US); Dale J. Brush, Manhattan, MT (US)

(21) Appl. No.: 18/831,891

(22) Filed: Oct. 31, 2025

Related U.S. Application Data
(60) Provisional application No. 63/779,609, filed on Mar. 28, 2025.

(51) Int. Cl. B23K 9/095

(52) U.S. Cl. CPC B23K 9/0956

(57) ABSTRACT

An imaging system that achieves a 360°view around a welding torch using a method that combines multiple images into a single image so there is no obstruction from the welding torch or the welding torch electrode. The system uses two or more cameras to digitally combine multiple images into a single image focused via an arrangement of lenses and directing light via fiber optic light guides into a single camera. Thermal measurements are taken using the cameras, which are capable of detecting the wavelengths of light and performing thermal analysis. Data processing is provided to create a weld pool profile using a spectroscopic evaluation of the welding shielding gas. This system improves the arc additive manufacturing and welding process by monitoring the weld pool size and shape in real-time for identification of anomalies during the welding process that can lead to insufficient weld deposits and deleterious weld properties.

### CROSS REFERENCE TO RELATED APPLICATIONS

This application claims the benefit of U.S. Provisional Patent Application 63/779,609 filed on Mar. 28, 2025 and incorporated herein by reference.

### FIELD OF THE INVENTION

This invention relates to an imaging system for the melt pool of a welding torch, and more particularly to an imaging system for the melt pool of a welding torch that provides a 360 degree view of the melt pool without obstruction by the welding torch electrode.

### BACKGROUND

Joining processes for welding and directed energy deposition (DED), use a heat source to melt and coalesce through continued deposition of layers or weld beads. These DED or welding processes may include Gas Tungsten Arc (GTAW), Plasma Arc (PAW), Laser Beam (LBW) and Electron Beam (EBW) and are common methods used in industrial applications. Monitoring of the weld pool during additive manufacturing (AM) or welding processes is a crucial step to maintain and verify part quality. The weld/melt pool size, shape and temperature gradient will dictate characteristics, i.e., microstructure, mechanical properties, and thermal distortion of the deposit, which will directly influence the quality and performance of each AM layer or weld pass. Monitoring the weld pool/melt, temperature gradient and/or gas composition can aid in process control, identifying flaws, and help ensure improved joint or component quality.

Current cameras capable of viewing the weld pool are limited to monitoring a fixed or one-dimensional travel direction relative to the welding torch because the camera must be positioned in a fixed orientation with an off-axis view of the weld/melt pool, as in U.S. Pat. No. 5,475,198 . Therefore, these devices are physically restricted from truly capturing the entire molten pool/melt and monitoring/tracking specific information, such as weld pool size and shape.

Cameras and algorithms have been developed to view the weld pool or welding electrodes and attempts have been made to track the information or measure the temperature fields in and surrounding the weld pool, U.S. Pat. No. 9,415,459B2. Many of these developments are for other processes such as LB or EB powder bed fusion, U.S. Pat. No. 11,478,854B2 . However, no device exists that combines information from multiple cameras or directs light from a 360° view around the welding torch to a camera or multiple cameras, and prior art does not contain programmatic post-processing algorithms to display and quantify two-dimensional material conditions around the weld or melt pool with direct and unimpeded views.

The current state of cameras for viewing the weld pool and monitoring temperature profiles require a fixed position of a camera oriented off-axis to the welding electrode. A major drawback is that these methods do not allow for sufficiently tracking the weld pool if the robotic or mechanized manipulation of the welding torch does not follow a one-dimensional path. Similarly, a single camera view always results in a blind spot or weld pool region that cannot be imaged because of the torch body, electrode, and/or filler metal integral to the DED processes. This single view camera setup also requires minimal obstructions along the weld joint for camera access and is generally limited to viewing welds in simple joint geometries. Therefore, AM and mechanized/robotic welding applications are restricted from high quality, feature-rich viewing of the whole weld pool and surrounding regions.

Therefore, a need exists to improve the design of visual and/or thermal camera systems used for DED and welding process monitoring that specifically allows for direct viewing of the entire weld pool without directional limitations.

### SUMMARY OF THE INVENTION

This invention solves the need to detect, without obstruction, the entire surface geometry of the weld pool/melt, the solidified weld bead, surrounding weld pool/melt region, account for changing weld pool dimensions and measure the temperature gradient in and surrounding the weld pool/melt via algorithms developed for the vision system. The volumetric quality, mechanical properties and performance of a weld or welded part are dependent upon the weld pool/melt size, shape and temperature gradient. For consistency, having a means for sensing the weld pool characteristics and temperature gradient would be advantageous during welding.

This invention relates to an imaging system for electric arc or laser welding where an optical system provides an unobstructed view of the weld pool/melt, solidified weld bead and surrounding region. The imaging system is capable of displaying a 360 degree view of the melt pool without obstruction by an electrode or other heat source conveyance means of the welding torch by combining multiple images from at least two cameras.

The imaging system comprises a first camera, a second camera, a gas cup, the welding torch and, an image processing computer. The first camera comprises a first camera lens, a first camera housing and is connected to the top of a torch camera assembly. The second camera comprises a second camera lens, a second camera housing and is also connected to the top of the torch camera assembly. The gas cup comprises a lower portion and is connected to the bottom of the torch camera assembly. The welding torch extends at least partially into the gas cup. The melt pool is created on a workpiece at an end of an electrode, contact tip or other heat source conveyance means of the welding torch during operation of the welding torch inside the gas cup.

The image processing computer receives image information from the first camera and from the second camera and, displays the 360 degree view of the melt pool without obstruction by the electrode, contact tip or other heat source conveyance means of the welding torch.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a schematic of an Omni-Directional-Melt Pool Viewer (OD-MPV) for gas metal arc or flux cored arc welding using a rigid optic configuration;

FIG. 2 is a schematic of an OD-MPV for gas metal arc or flux cored arc welding using a flexible light guide optic configuration;

FIG. 3 is a schematic of an OD-MPV for gas tungsten arc or plasma arc welding using a rigid optic configuration;

FIG. 4 is a schematic of an OD-MPV for gas tungsten arc or plasma arc welding using a flexible light guide optic configuration;

FIG. 5 is a schematic of an OD-MPV for laser beam welding using a rigid optic configuration;

FIG. 6 is a schematic of an OD-MPV for laser beam welding using a flexible light guide configuration;

FIG. 7 shows the two images that are captured from the two cameras or two light guides of the present OD-MPV;

FIG. 8 shows the two images after they have been stitched together with the OD-MPV algorithm;

FIG. 9 shows the dimensions of the weld pool that are calculated after combination of the two images;

FIG. 10 shows a schematic of the cross-section of the weld pool, weld deposit, the measured temperature and thermal gradient from the cameras and image processing computer;

FIG. 11 shows an image of the OD-MPV gas cup with the optional fiber optic light guide for a spectrometer and processing computer;

FIG. 12 shows exemplary output from the spectrometer and processing computer; and,

FIG. 13 is a flow chart illustrating exemplary steps in an OD-MPV computer algorithm.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,”“below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element. When the words “substantially” or “about” are used, if a quantitative measurement is necessary, within 95% of “complete” or “exact” should be considered the meaning. The term “the invention” or “the present invention” should always be construed as “an embodiment of the invention.”

The following description for the present invention describes exemplary components that are involved in the full assembly and functionality of exemplary Omni-Directional-Melt Pool Viewer (OD-MPV) and do not restrict the use of the OD-MPV to any or all the items defined. This description is solely to define how the OD-MPV integrates and works. The OD-MPV system is intended to be used in any application of a fusion welding process for viewing of the entire weld pool without process-related viewing obstructions.

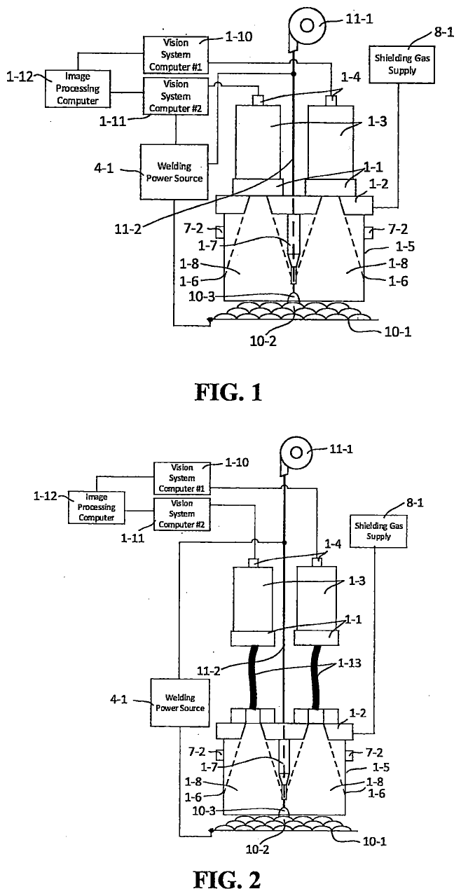

FIG. 1 illustrates an Omni-Directional-Melt Pool Viewer (OD-MPV) for Gas Metal Arc and Flux Cored Arc Welding using rigid optics. The body of the OD-MPV contains cameras 1-1, camera housings 1-3, an assembly 1-2 to affix the cameras 1-1, optical filters, collimating/focusing/cover lenses (not shown), ports for passage of process gas to protect the cameras and camera lens assembly, and ports for passage of shielding gas 8-1 to the weld location. The assembly shows a torch body and contact tip 1-7 for passing the welding wire 11-2 from the wire spool 11-1 and electric current from the power source 4-1. The gas cup 1-5 is connected to upper torch assembly 1-2. The connections for the optional, fiber spectrometer 7-2 are also shown near the top of the gas cup 1-5. The projected views 1-8 of both cameras 1-1 around the contact tip 1-7 and arc column 10-3 to the surface of the weld pool 10-2 and surrounding regions of material or weld metal deposit 10-1 are shown.

The output 1-4 from the cameras 1-1 are sent to the vision system computers, 1-10 and 1-3 to produce individual images from each camera. The images from the vision system computers are sent to an image processing computer 1-12 to merge the two images into a single, unobstructed view of the weld pool 10-2.

FIG. 2 illustrates an Omni-Directional-Melt Pool Viewer (OD-MPV) for Gas Metal Arc and Flux Cored Arc Welding using flexible optics. The body of the OD-MPV contains cameras 1-1, camera housings 1-3, flexible light guides 1-13, an assembly 1-2 to affix the 10 light guides 1-13, optical filters, focusing/cover lenses (not shown), ports for passage of process gas to protect the optics, light guide assembly, and ports for passage of shielding gas 8-1 to the weld location. The assembly shows a torch body and contact tip 1-7 for passing the welding wire 11-2 from the wire spool 11-1 and electric current from the power source 4-1. The gas cup 1-5 is connected to upper torch assembly 1-2. The connections 7-2 for the optional, fiber spectrometer are also shown near the top of the gas cup 1-5. The projected views 1-8 of both cameras 1-1 around the contact tip 1-7 and arc column 10-3 to the surface of the weld pool 10-2 and surrounding regions of material or weld metal deposit 10-1 are shown.

The output 1-4 from the cameras 1-1 are sent to the vision system computers, 1-10 and 1-21 to produce individual images from each camera. The images from the vision system computers are sent to an image processing computer 1-12 to merge the two images into a single, unobstructed view of the weld pool 10-2 and surrounding regions. The image processing computer 1-12 uses a first computer algorithm to merge the two images from the two cameras 1-1 into one single image.

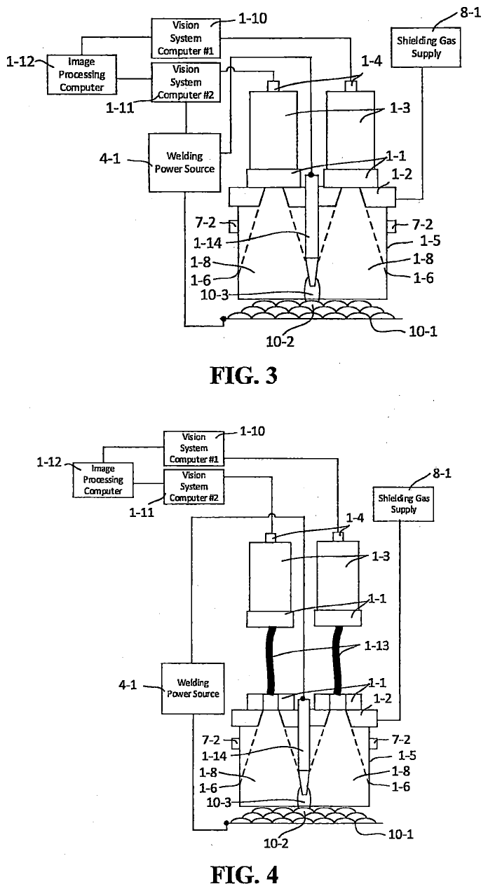

FIG. 3 illustrates an Omni-Directional-Melt Pool Viewer (OD-MPV) for gas tungsten arc and plasma arc welding using rigid optics. The body of the OD-MPV contains cameras 1-1, camera housings 1-3, an assembly 1-2 to affix the cameras, optical filters, collimating/focusing/cover lenses (not shown), ports for passage of process gas to protect the cameras 1-1 and camera lens assembly, and ports for passage of shielding gas 8-1 to the weld location. The torch assembly has a non-consumable tungsten electrode 1-14 for establishing the weld pool 10-2 by passing the electric current from the power source 4-1. The gas cup 1-5 is connected to upper torch assembly 1-2. The connections 7-2 for the optional, fiber spectrometer are also shown near the top of the gas cup 1-5. The projected views 1-8 of both cameras 1-1 around the electrode 1-14 and arc column 10-3 to the surface of the weld pool 10-2 and surrounding regions of material or weld metal deposit 10-1 are shown.

The output 1-4 from the cameras 1-1 are sent to the vision system computers 1-10 and 1-18 to produce individual images from each camera. The images from the vision system computers 1-10 and 1-11 are sent to an image processing computer 1-12 to merge the two images into a single, unobstructed view of the weld pool 10-2 and surrounding regions. The image processing computer 1-12 uses a first computer algorithm to merge the two images from the two cameras 1-1 into one single image.

FIG. 4 illustrates an Omni-Directional-Melt Pool Viewer (OD-MPV) for gas tungsten arc and plasma arc welding using flexible optics. The body of the OD-MPV contains cameras 1-1, camera housings 1-3, flexible light guides 1-13, an assembly 1-2 to affix the light guides, optical filters, focusing/cover lenses (not shown), ports for passage of process gas to protect the optics, light guide assembly, and ports for passage of shielding gas 8-1 to the weld location. The assembly shows a torch body and non-consumable tungsten electrode 1-14 for establishing the weld pool 10-2 by passing the electric current from the power source 4-1. The gas cup 1-5 is connected to upper torch assembly 1-2. The connections 7-2 for the optional, fiber spectrometer are also shown near the top of the gas cup 1-5. The projected views 1-8 of both cameras 1-1 around the tungsten electrode 1-14 and arc column 10-3 to the surface of the weld pool 10-2 and surrounding regions of material or weld metal deposit 10-1 are shown.

The output 1-4 from the cameras 1-1 are sent to the vision system computers 1-10 and 1-16 to produce individual images from each camera. The images from the vision system computers 1-10 and 1-11 are sent to an image processing computer 1-12 to merge the two images into a single, unobstructed view of the weld pool 10-2 and surrounding regions. The image processing computer 1-12 uses a first computer algorithm to merge the two images from the two cameras 1-1 into one single image.

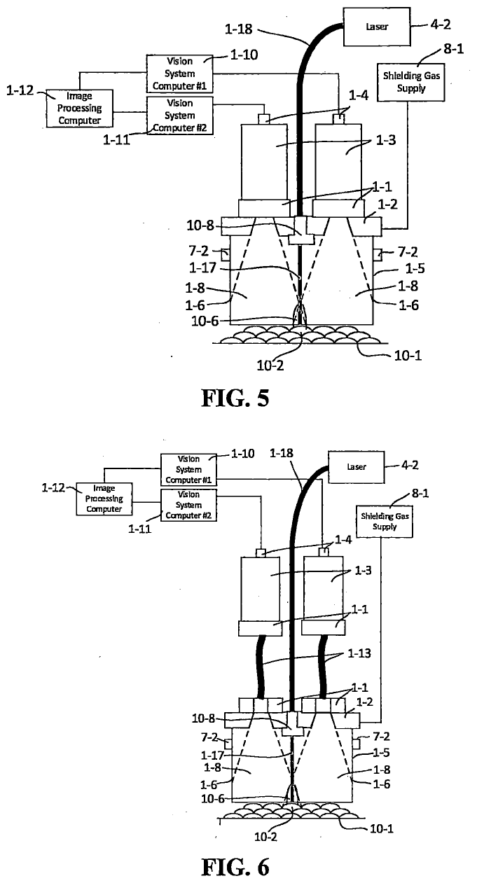

FIG. 5 illustrates an Omni-Directional-Melt Pool Viewer (OD-MPV) for laser beam welding using rigid optics. The body of the OD-MPV contains cameras 1-1, camera housings 1-3, an assembly 1-2 to affix the cameras, optical filters, collimating/focusing/cover lenses (not shown), ports for passage of process gas to protect the cameras 1-1 and camera lens assembly, and ports for passage of shielding gas 8-1 to the weld location. The torch assembly has a light guide 1-18 for the light produced by the laser 4-2, laser optics 10-8 for establishing the weld pool 10-2. The gas cup 1-5 is connected to upper torch assembly 1-2. The connections 7-2 for the optional, fiber spectrometer are also shown near the top of the gas cup 1-5. The projected views 1-8 of both cameras 1-1 around the collimated laser light focus spot and laser plume 10-6 to the surface of the weld pool 10-2 and surrounding regions of material or weld metal deposit 10-1 are shown.

The output 1-4 from the cameras 1-1 are sent to the vision system computers 1-10 and 1-13 to produce individual images from each camera. The images from the vision system computers 1-10 and 1-11 are sent to an image processing computer 1-12 to merge the two images into a single, unobstructed view of the weld pool 10-2 and surrounding region. The image processing computer 1-12 uses a first computer algorithm to merge the two images from the two cameras 1-1 into one single image.

FIG. 6 illustrates an Omni-Directional-Melt Pool Viewer (OD-MPV) for laser beam welding using flexible optics. The body of the OD-MPV contains cameras 1-1, camera housings 1-3, flexible light guides 1-13, an assembly 1-2 to affix the light guides, optical filters, focusing/cover lenses (not shown), ports for passage of process gas to protect the optics, light guide assembly, and ports for passage of shielding gas 8-1 to the weld location. The torch assembly has a light guide 1-18 for the light produced by the laser 4-2, laser optics 10-8 for establishing the weld pool 10-2. The gas cup 1-5 is connected to upper torch assembly 1-2. The connections 7-2 for the optional, fiber spectrometer are also shown near the top of the gas cup 1-5. The projected views 1-8 of both cameras 1-1 around the collimated laser light focus spot and laser plume 10-6 to the surface of the weld pool 10-2 and surrounding regions of material or weld metal deposit 10-1 are shown.

The output 1-4 from the cameras 1-1 are sent to the vision system computers 1-10 and 1-10 to produce individual images from each camera. The images from the vision system computers 1-10 and 1-11 are sent to an image processing computer 1-12 to merge the two images into a single, unobstructed view of the weld pool 10-2 and surrounding region. The image processing computer 1-12 uses an OD-MPV computer algorithm to merge the two images from the two cameras 1-1 into one single image.

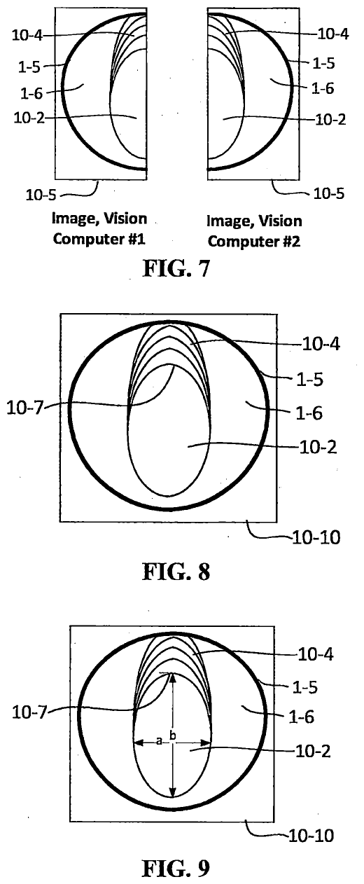

FIG. 7 illustrates the individual images 10-5 of the weld pool 10-2, solidified weld beads 10-4, and surrounding weld pool region 1-6 captured within the gas cup 1-5 from the Omni-Directional-Melt Pool Viewer (OD-MPV) cameras 1-1 that are received by the Image Vision Computer #1 and the Image Vision Computer #2.

FIG. 8 illustrates the result of combining the two images from FIG. 7 into one, single image 10-10 of the weld pool 10-2, solidified weld beads 10-4, and surrounding weld pool region 1-6, including the molten weld pool boundary 10-7, captured within the gas cup 1-5 from the Omni-Directional-Melt Pool Viewer (OD-MPV) cameras 1-1.

FIG. 9 illustrates the combined image 10-10 of the weld pool 10-2, solidified weld beads 10-4, and surrounding weld pool region 1-6, including the molten weld pool boundary 10-7, captured within the gas cup 1-5 from the Omni-Directional-Melt Pool Viewer (OD-7 MPV) cameras 1-1 where the image processing computer 1-12 determines the weld pool width (a), length (b) and shape using the OD-MPV computer algorithm.

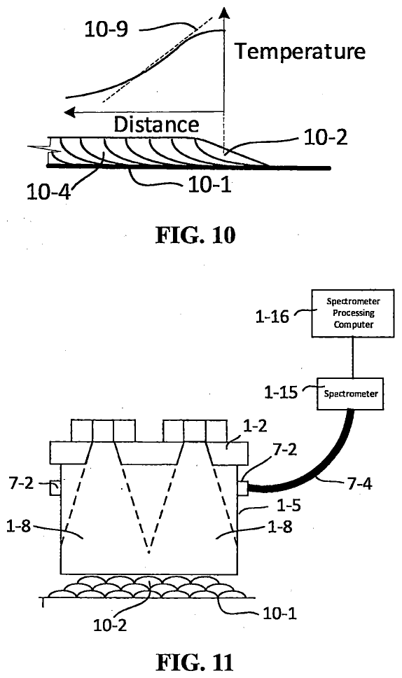

FIG. 10 is a cross-sectional view of the combined image from FIG. 9 comprised of the weld pool 10-2, solidified weld beads 10-4, and surrounding weld pool region captured within the gas cup 1-5 from the Omni-Directional-Melt Pool Viewer (OD-MPV) cameras 1-1 where the image processing computer 1-12 determines the temperature and cooling rate 10-9 of the weld pool and weld deposit. The image processing computer 1-12 uses the OD-MPV computer algorithm to determine the temperature and cooling rate 10-9.

FIG. 11 illustrates an Omni-Directional-Melt Pool Viewer (OD-MPV) torch body assembly 1-2 and gas cup 1-5 with a fiber optic light guide 7-4 connected to the gas cup 1-5 at the connector 7-2. The light guide 7-4 is connected to an optional shielding gas optical spectrometer 1-15. The optical spectrometer 1-15 is further connected to a spectrometer processing computer 1-16. The optional spectrometer 1-15 is connected to the gas cup 1-5 using a fiber optic light guide 7-4. The fiber optic light guide 7-4 collects light from the ionized shielding gas within the gas cup 1-5. The light is analyzed by the spectrometer 1-15 and further analyzed by the spectrometer processing computer 1-16. The spectrometer processing computer 1-16 uses a second computer algorithm to identify the elemental species responsible for the spectral emission peaks. The algorithm also identifies the presence of process contaminants and elemental species of interest.

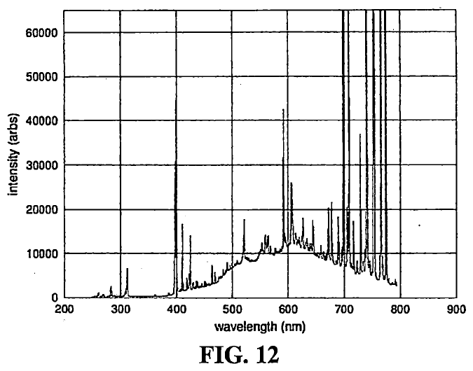

FIG. 12 illustrates a typical output from the spectrometer 1-15 and processing computer 1-16 to identify the ionized species wavelength present in the shielding atmosphere. An example of the spectrographic data collected from the ionized shielding gas is shown in FIG. 12.

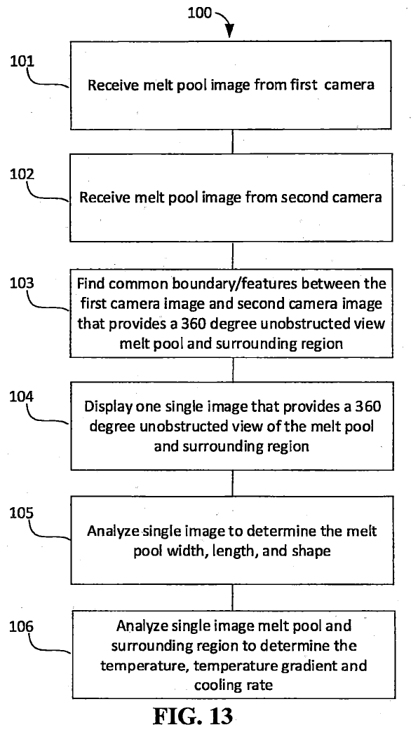

FIG. 13 is a flow chart illustrating exemplary steps in the OD-MPV computer algorithm 100. In step 101, the image that is output from vision system computer 1-10 is received by image processing computer 1-12. In step 102, the image that is output from vision system computer 1-11 is received by image processing computer 1-12. In step 103, the image processing computer 1-12 determines a common boundary between the two images, by matching common features between the two images, and the two images are stitched together along the common boundary. The common boundary is determined so that the resulting image provides a 360 degree view of the weld pool, and surrounding weld pool region, that is unobstructed by the electrode or contact tip. In step 104, the single image that provides the 360 degree view of the melt pool, without obstruction by the electrode or by the contact tip, is displayed. In step 105, the OD-MPV computer algorithm analyzes a single, combined image to determine the width, length and shape of the melt pool. In step 106, the OD-MPV computer algorithm analyzes the single, combined image to determine a temperature gradient for the melt pool and surrounding region. This information is used to calculate a cooling rate for the region. Features of welds, such as length, width, shape and cooling rate are important. They are used to identify good welds and weld that may have flaws. The OD-MPV automatically saves all information determined for each weld as a profile for that weld.

The imaging techniques presented herein uses two or more cameras, or two more light guides. The OD-MPV computer algorithm is used to combine two or more images that are synchronously captured for display and further processing. An example of this display and processing is shown in FIG. 7 and FIG. 8. FIG. 7 illustrates the two separate images captured by the cameras 1-1 and displayed by the vision system computers 1-10 and 1-11. Referring back to FIG. 1, the two cameras 1-1 project an overlapping view 1-8 at the weld pool surface 10-2 where the cameras 1-1 are positioned to prevent the majority of the high-intensity light produced by the welding arc 10-3 or laser plasma plume 10-6 (shown in FIG. 5) from reaching the camera lens assembly 1-2. Because the Omni-Directional-Melt Pool Viewer (OD-MPV) design prevents the high intensity arc light from reaching the lens assembly, the resulting camera images 10-5 have significantly improved contrast because the high-intensity light cannot saturate the image detector in the cameras 1-1. Both camera views (FIG. 7) are stitched together to attain the single view (FIG. 8 and FIG. 9) that comprises the entire circumference within the gas cup 1-5. After a cohesive image is obtained, the OD-MPV computer algorithm detects the width (a), the length (b), the shape of the weld pool 10-2, and the weld pool molten boundary 10-7. Then the OD-MPV computer algorithm is used to detect the relative temperature and thermal profile or cooling rate 10-8 (FIG. 10). After the molten weld pool boundary 10-7, weld pool dimensions and thermal profiles are detected, another computer algorithm can process the information to discern the orientation and travel direction of the weld pool 10-2. The information can also be used to access the process conditions relative to a user-defined benchmark.

While a particular form of the invention has been illustrated and described, it will be apparent that various modifications can be made without departing from the spirit and scope of the invention. For example, more than two cameras can be used or more than two light guides could be used. Further, a means of mobility, such as a robotic arm, could be added to provide movement of the arc welding torch. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. An imaging system for viewing a melt pool through a center of a welding torch, the imaging system capable of displaying a 360 degree view of the melt pool without obstruction by an electrode of the welding torch by combining multiple images from at least two cameras, the imaging system comprising:
a first camera, the first camera comprising a first camera lens, a first camera housing and being connected to a top of a camera assembly;
a second camera, the second camera comprising a second camera lens, a second camera housing and being connected to the top of the camera assembly;
a gas cup, the gas cup comprising a lower portion and being connected to a bottom of the camera assembly;
the welding torch, wherein the electrode of the welding torch extends into the gas cup, and further wherein the melt pool is created on a workpiece at an end of a contact tip of the welding torch during operation of the welding torch inside the gas cup; and,
an image processing computer that receives image information from the first camera and from the second camera, and displays the 360 degree view of the melt pool without obstruction by the electrode or by the contact tip of the welding torch.

2. The imaging system of claim 1, wherein the image information that the image processing computer receives, comprises a first image of the melt pool from the first camera and a second image of the melt pool from the second camera and the image processing computer combines the first image of the melt pool and the second image of the melt pool into one single image of the melt pool that is displayed as the 360 degree view of the melt pool.

3. The imaging system of claim 1, wherein the image processing computer uses an OD-7 MPV computer algorithm to create the 360 degree view of the melt pool from the image information from the first camera and the second camera.

4. The imaging system of claim 1, wherein the image processing computer further detects features of the melt pool based on the image information received from the first camera and the second camera, and further wherein the features of the melt pool comprise: a length; a width; a temperature; and anomalous features of interest.

5. The imaging system of claim 1, wherein the welding torch is used in an arc welding process comprising: Gas Tungsten Arc Welding (GTAW); Gas Metal Arc Welding (GMAW); Flux Cored Arc Welding (FCAW); and, Plasma Arc Welding (PAW).

6. The imaging system of claim 1, wherein laser beam welding is used as the welding torch.

7. The imaging system of claim 1, further comprising a spectrometer processing computer that calculates and displays a spectroscopic evaluation of the shielding gas in real-time.

8. The imaging system of claim 1, wherein the image processing computer uses the image information for real-time, in-build evaluation of a weld, and further wherein the image processing computer stores the image information for post-build evaluation of the weld.

9. The imaging system of claim 8, wherein the image processing computer creates a weld profile for the weld based on the in-build evaluation of the weld and optionally based on the post-build evaluation of the weld.

10. The imaging system of claim 1, further comprising:
a welding electrode spool, wherein the welding electrode of the welding electrode spool extends at least partially through the welding torch; and,
a shielding gas supply, wherein the shielding gas supply provides shielding gas to the gas cup during operation of the welding torch.

11. An imaging system for viewing a melt pool through a center of a welding torch, the imaging system capable of displaying a 360 degree view of the melt pool without obstruction by an electrode of the welding torch by combining multiple images from at least two light guides, the imaging system comprising:
a first light guide, the first light guide comprising a first lens, a first coherent fiber bundle, a first housing and being connected to a top of a light guide assembly;
a second light guide, the second light guide comprising a second lens, a second coherent fiber bundle, a second housing and being connected to the top of the light guide assembly;
a gas cup, the gas cup comprising a lower portion and being connected to a bottom of the light guide assembly;
the welding torch, wherein the electrode of the welding torch extends into the gas cup, and further wherein the melt pool is created at a workpiece at an end of a contact tip of the welding torch during operation of the welding torch inside the gas cup; and,
an image processing computer that receives image information from the first light guide and from the second light guide, and displays the 360 degree view of the melt pool without obstruction by the electrode or by the contact tip of the welding torch.

12. The imaging system of claim 11, wherein the image information that the image processing computer receives, comprises a first image of the melt pool from the first light guide and a second image of the melt pool from the second light guide, and the image processing computer combines the first image of the melt pool and the second image of the melt pool into one single image of the melt pool that is displayed as the 360 degree view of the melt pool.

13. The imaging system of claim 11, wherein the image processing computer uses an OD-MPV computer algorithm to create the 360 degree view of the melt pool from the image information from the first light guide and the second light guide.

14. The imaging system of claim 11, wherein the image processing computer further detects features of the melt pool based on the image information received from the first light guide and the second light guide, and further wherein the features of the melt pool comprise: a length; a width; a temperature; and anomalous features of interest.

15. The imaging system of claim 11, wherein the welding torch is used in an arc welding process comprising: Gas Tungsten Arc Welding (GTAW); Gas Metal Arc Welding (GMAW); Flux Cored Arc Welding (FCAW); and, Plasma Arc Welding (PAW).

16. The imaging system of claim 11, wherein laser beam welding is used as the welding torch.

17. The imaging system of claim 11, further comprising a spectrometer processing computer that calculates and displays a spectroscopic evaluation of the shielding gas in real-time.

18. The imaging system of claim 11, wherein the image processing computer uses the image information for real-time, in-build evaluation of a weld, and further wherein the image processing computer stores the image information for post-build evaluation of the weld.

19. The imaging system of claim 18, wherein the image processing computer creates a weld profile for the weld, based on the in-build evaluation of the weld and optionally based on the post-build evaluation of the weld, and further wherein the weld profile is remotely stored.

20. The imaging system of claim 11, further comprising:
a welding electrode spool, wherein the welding electrode of the welding electrode spool extends at least partially through the welding torch; and,
a shielding gas supply, wherein the shielding gas supply provides shielding gas to the gas cup during operation of the welding torch.
